(19) United States
(12) Patent Application Publication
(10) Pub. No.: US 2015/0317050 A1
(43) Pub. Date: Nov. 5, 2015

(54) E-BOOK GIFTING

(71) Applicant: Kobo Inc., Toronto (CA)

(72) Inventor: Benjamin Landau, Toronto (CA)

(73) Assignee: Kobo Inc., Toronto (CA)

(21) Appl. No.: 14/268,928

(22) Filed: May 2, 2014

(51) Int. Cl. G06F 3/0483; H04L 29/08; G06F 3/0481

(52) U.S. Cl. CPC G06F 3/0483; G06F 3/04817; H04L 67/06; H04L 67/10

(57) ABSTRACT

A computing device displays a user activatable trigger along with a content portion of the e-book when the e-book is rendered for reading. The computing device detects activation of the trigger by user input. The computing device generates communication for a network service from which the e-book is available for download. The generated communication can include an identifier for each of the e-book, the user, and a recipient. According to some embodiments, at least a portion of the communication corresponding to the identifier of the e-book is identified and automatically provided as part of the communication. The communication can then be transmitted the network service.

### TECHNICAL FIELD

Examples described herein relate to a system and method for gifting e-books.

### BACKGROUND

An electronic personal display is a mobile computing device that displays information to a user. While an electronic personal display may be capable of many of the functions of a personal computer, a user can typically interact directly with an electronic personal display without the use of a keyboard that is separate from or coupled to but distinct from the electronic personal display itself. Some examples of electronic personal displays include mobile digital devices/tablet computers such (e.g., Apple iPad®, Microsoft® Surface™, Samsung Galaxy Tab® and the like), handheld multimedia smartphones (e.g., Apple iPhone®, Samsung Galaxy S®, and the like), and handheld electronic readers (e.g., Amazon Kindle®, Barnes and Noble Nook®, Kobo Aura HD, and the like).

E-readers are purpose built devices designed to perform especially well at displaying readable content. For example, a purpose built e-reader may include a display that reduces glare, performs well in high lighting conditions, and/or mimics the look of text on actual paper. While such purpose built e-readers may excel at displaying content for a user to read, they may also perform other functions, such as displaying images, emitting audio, recording audio, and web surfing, among others.

There also exists numerous kinds of consumer devices that can receive services and resources from a network service. Such devices can operate applications or provide other functionality that links a device to a particular account of a specific service. For example, e-reader devices typically link to an online bookstore, and media playback devices often include applications which enable the user to access an online media library. In this context, the user accounts can enable the user to receive the full benefit and functionality of the device.

### BRIEF DESCRIPTION OF THE DRAWINGS

FIG. 1 illustrates a system for enabling gifting of e-book from an e-reader device, according to an embodiment.

FIG. 2 illustrates an example of an e-reader device for use with one or more embodiments described herein.

FIG. 3 illustrates an example device system for implementing e-book gifting on an e-reader device, according to an embodiment.

FIG. 4 illustrates an example method for enabling a user to gift an e-book, according to one or more embodiments.

FIG. 5A through FIG. 5C illustrate variations of examples for providing and in e-book gift feature, according to one or more embodiments.

FIG. 6 illustrates an example interface that can be displayed when a gift trigger feature is activated, according to an embodiment.

### DETAILED DESCRIPTION

Embodiments described herein provide an in-book gift trigger that enables a user to gift an e-book when the user reads or completes the e-book. Among other benefits, examples described herein provide prompts for triggering the user to gift an e-book while the user's interest in the e-book is high, thus promoting gift exchanges of e-books. In one aspect, examples described herein programmatically implement at least the step of identifying a user selection of an e-book for a gift exchange.

Additionally, examples described herein facilitate transactions in which e-books are gifted, and further automate some of the steps that would otherwise be cumbersome for the user to perform manually when gifting an e-book. For example, under some conventional approaches, a user has to search or type the title of an e-book in order to identify the e-book for a gift exchange. In contrast to such conventional approaches, examples described herein provide functionality that programmatically identifies the e-book that the user wishes to gift from the e-book that the user is reading.

In an embodiment, a computing device displays a user activatable trigger along with a content portion of the e-book when the e-book is rendered for reading. The computing device detects activation of the trigger by user input. The computing device generates communication for a network service from which the e-book is available for download. The generated communication can include an identifier for each of the e-book, the user, and a recipient. According to some embodiments, at least a portion of the communication corresponding to the identifier of the e-book is identified and automatically provided as part of the communication. The communication can then be transmitted the network service.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System and Device Description

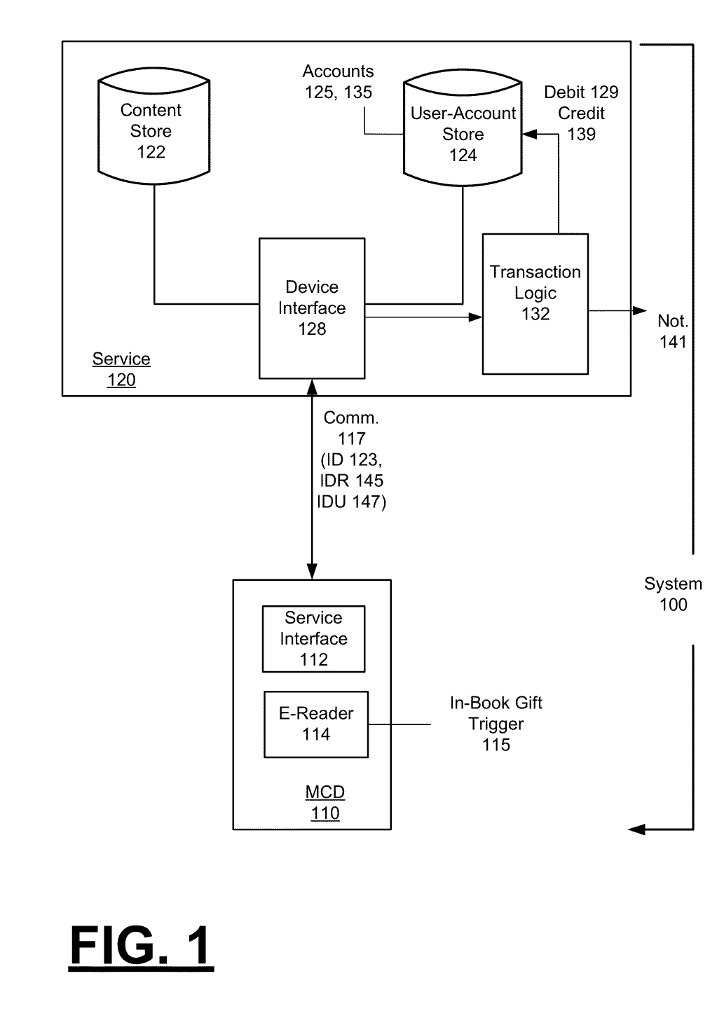

FIG. 1 illustrates a system for enabling gifting of e-book from an e-reader device, according to an embodiment. In an example of FIG. 1, system 100 includes an e-reader device 110 and a network service 120. The network service 120 may include multiple servers and other computing resources that provide various services in connection with one or more applications that are installed on the e-reader device 110. By way of example, in one implementation, the network service 120 can provide e-book services which communicate with corresponding e-book functionality provided on the e-reader device 110. The e-book services can enable e-books to be downloaded or archived from e-reader device 110. The network service 120 can also provide other forms of content for download or streaming, such as videos or music. In this way, the network service 120 can provide various other content services, including content rendering services (e.g., streaming media) or other network-application environments or services.

The e-reader device 110 can correspond to any electronic personal display device on which applications and application resources (e.g., e-books, media files, documents) can be rendered and consumed. For example, the e-reader device 110 can correspond to a tablet or a telephony/messaging device (e.g., smart phone). In one implementation, for example, e-reader device 110 can correspond to a mobile computing device (e.g., tablet) that runs an e-reader application to link the device to the network service 120 in order to enable e-books provided through the service to be viewed and consumed. Still further, by way of example, the e-reader device 110 can be equipped with hardware and software to optimize certain application activities, such as rendering of electronic content (e.g., e-books). For example, the e-reader device 110 can have a tablet like form factor, although variations are possible. In some cases, the e-reader device 110 can also have an E-ink display.

In additional detail, the network service 120 can include a device interface 128, a resource store 122 and a user account store 124. The user account store 124 can associate the e-reader device 110 with a user and with an account 125. The account 125 can also be associated with one or more application resources (e.g., content item such as an e-books), which can be stored in the resource store 122. As described further, the user account store 124 can retain metadata for individual accounts 125 to identify resources that have been purchased or made available for consumption for a given account. The e-reader device 110 may be associated with the user account 125, and multiple devices may be associated with the same account. As described in greater detail below, the e-reader device 110 can store resources (e.g., e-books) that are purchased or otherwise made available to the user of the e-reader device 110, as well as to archive e-books and other digital content items that have been purchased for the user account 125, but are not stored on the particular computing device.

The e-reader device 110 can include a service interface 112 and an e-reader component 114. The e-reader device 110 can execute the service interface 112 to receive resources and data from the network service 120. The service interface 112 can identify, for example, the user and an account number with the network service 120. The service interface 112 can interface with the network service 120 to receive resources such as applications and content items (e.g., e-books, music files, etc.) from the network service. The e-reader device 110 can communicate with multiple services in order to receive resources.

The e-reader device 110 can execute the e-reader component 114 to enable e-reading activities. In particular, the e-reader component 114 can render paginated content from e-books (e.g., electronically formatted literary works, including periodicals). According to some embodiments, the e-reader component 114 includes logic for providing an in-book gift trigger 115. The gift trigger 115 can be displayed as an interactive feature when individual e-books are rendered through the e-reader component 114. In particular, the gift trigger 115 can be provided as a feature that is provided with the e-book being rendered. The user can activate the gift trigger 115 with a designated input. For example, the gift trigger 115 can be displayed as an icon or other soft-feature that can be activated when the user touches a corresponding region of a display of the e-reader device 110. When activated, the gift trigger 115 can execute to prompt the user to provide an identifier 125 of the recipient. By way of example, the identification of the recipient can be by name, account identifier, or email address.

When activated, the gift trigger 115 can generate a communication 117 that includes an identifier 123 of the e-book. The gift trigger 115 can automatically insert an identifier of the e-book into the communication. In one implementation, the identifier of the e-book can correspond to an ISBN (International Standard Book Number). In variations, other numeric identifiers can be utilized that can enable the network service 120 to identify the e-book. Still further, the identifier of the e-book can be provided by title, author, or in the case of periodicals, by title, volume and issue number. The gift trigger 115 can also generate a programmatic process to obtain the identifier 145 of the recipient and an identifier 147 of the user (or user account). The identifier of the user or user account can be stored on the e-reader device 110 and provided through, for example, the service interface 112. The gift trigger 115 can implement the programmatic process to identifying the recipient by for example, displaying an interface with the content of the e-book that enables the user to identify the recipient by email address, name or other identifier. The gift trigger 115 can populate some or all of the communication 117 with the identifier 123 of the e-book, the identifier of the recipient 145, and the identifier 147 of the user account 125. In some variations, the identifier of the user (or user account 125) can be provided from device hardware, firmware or through service interface 112.

Still further, the identifier of the recipient 145 can be obtained, or suggested to the user, through programmatic analysis. By way of example, the programmatic analysis can include performing historical analysis (e.g., individuals the user previously gifted), or pre-established gift lists for the particular user.

The communication 117 can be received by the network service 120, which can parse the communication and execute transaction logic 132. The transaction logic 132 includes logic to implement a transaction identified by the communication 117. In one implementation, the transaction logic 132 implements the transaction by (i) issuing a debit 129 of funds to the account 125 of the user, and (ii) issuing a credit 139 to a corresponding account 135 of the recipient with the e-book of identifier 123. The particular e-book can then be made available for download to the recipient. The transaction logic 132 can also generate a notification 141 for the recipient to inform them of the gifted e-book. Still further, in some variations, the transaction logic 132 can automatically download the gifted e-book onto one or more devices associated with the account 135 of the recipient.

In some variations, the transaction logic 132 can implement the gifting of the e-book by debiting the e-book of the identifier 125 from the account 135 of the recipient. In one implementation, the user can be precluded from accessing at least the content portion of the e-book of identifier 123. For example, the gifted e-book can be deleted from the device of the user (as well as other devices), and the account 125 can be updated to omit the gifted e-book from the list of e-books associated with that account.

Hardware Description

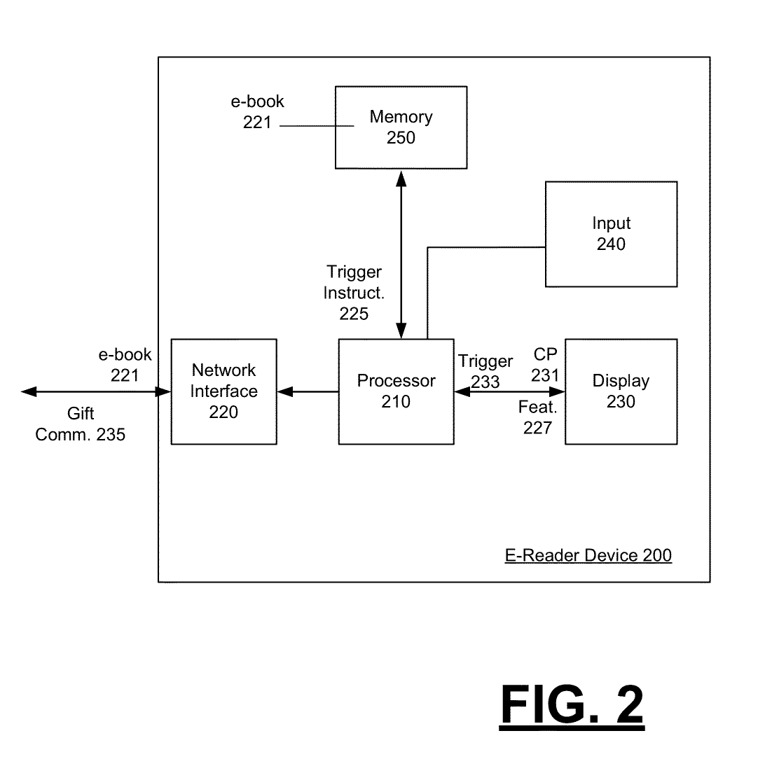

FIG. 2 illustrates an example of an e-reader device for use with one or more embodiments described herein. In an example of FIG. 2, an e-reader device 200 can correspond to, for example, a mobile computing device such as shown by an example of FIG. 1.

With reference to FIG. 2, e-reader device 200 includes a processor 210, a network interface 220, a display 230, one or more input mechanisms 240, and a memory 250. The processor 210 can implement functionality using instructions stored in the memory 250. Additionally, in some implementations, the processor 210 utilizes the network interface 220 to communicate with the network service 120 (see FIG. 1). More specifically, the e-reader device 200 can access the network service 120 to receive various kinds of resources (e.g., digital content items such as e-books, configuration files, account information), as well as to provide information (e.g., user account information, service requests etc.). For example, e-reader device 200 can receive application resources, such as media files 221 (e.g., e-books) that the user elects to purchase or otherwise download from the network service 120. The application resources that are downloaded onto the e-reader device 200 can be stored in the memory 250.

In some implementations, the display 230 can correspond to, for example, a liquid crystal display (LCD) or light emitting diode (LED) display that illuminates in order to provide content generated from processor 210. In some variations, the display 230 can correspond to an electronic paper type display, which mimics conventional paper in the manner in which they display content. Examples of such display technologies include electrophoretic displays, electrowetting displays, and electrofluidic displays.

In some implementations, the display 230 can be touch-sensitive. For example, the display 230 can be integrated with a sensor layer that is comprised of capacitive touch sensors which trigger with contact to human skin. Alternatively, the display 230 can include alternative sensor layers, such as resistive sensors which can detect applied pressure from, for example, a human finger or stylus.

The processor 210 can receive input from various sources, including from input mechanisms 240 (e.g., buttons or switches, microphone, keyboard), the display 230 (e.g., soft buttons or virtual keyboard) or other input mechanisms (accessory devices). In one implementation, the processor 210 can process multi-touch input detected by the sensor layer provided on the display 230.

In one aspect, memory 250 stores instructions 225 (“trigger instructions 225”) for enabling a user to trigger gifting of an e-book that is being viewed. The processor 210 can execute the instructions 225 to generate an in-book feature 227 that is displayed with, or concurrently to, a content portion 231 of a given e-book 221. In one implementation, the in-book feature 227 can correspond to an icon or prompt that is provided within the boundary of the e-book and/or as part of the feature set when the e-book is viewed. The processor 210 can detect trigger 233, corresponding to an input generated through a user interaction with the feature 227. In one implementation, the feature 227 can, once activated by user input, provide a prompt for the user to enter input identifying a recipient of the e-book 221 being viewed.

Responsive to detecting the trigger 233, the processor 210 can generate a gift communication 235 that is communicated to the network service 120 via the network interface 220. The gift communication 235 can identify the e-book 221 from which the trigger 233 was generated, as well as the recipient of the e-book 221. The processor 210 and/or network interface 220 can also include an identifier for the account or user of the device 200. The gift communication 235 can be communicated to the network service 120, where it is implemented by the transaction logic 132 (see FIG. 1).

Device System

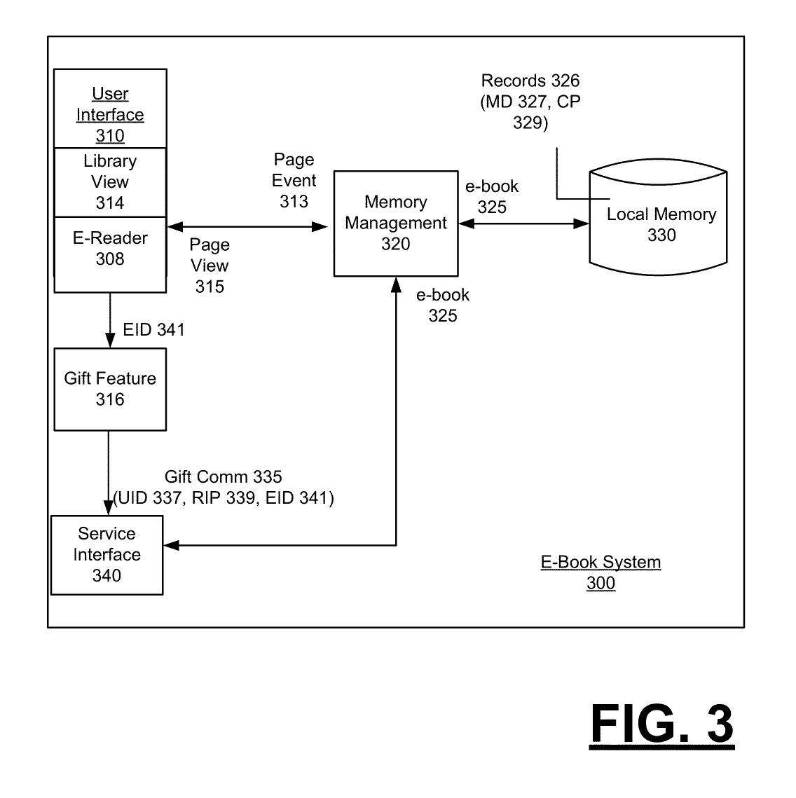

FIG. 3 illustrates an example device system for implementing e-book gifting on an e-reader device, according to an embodiment. In reference to FIG. 3, a system 300 implements programmatic components for communicating with one or more network service (such as network service 120, shown in FIG. 1), as well as for enabling functionality for viewing and accessing content items (e.g., e-books) utilized by an account associated with the e-reader device 110 (see FIG. 1). In some embodiments, the system 300 can be implemented as an application that runs on an e-reader device, such as shown with examples of FIG. 1 or FIG. 2. In variations, the system 300 can be implemented as part of the operating system for the e-reader device.

In an example of FIG. 3, system 300 includes a user interface 310, a memory management module 320, a local memory 330, and a service interface 340. Some or all of the programmatic components shown with the computing system 300 can be provided in part as operating system-level components. Alternatively, the programmatic components shown with the computing system 300 can be provided as part of an application that runs on, for example, the e-reader device 110. For example, the user can download an application onto the device that is operated as the e-reader device 110, in order to obtain functionality such as described with an example of FIG. 3. For example, the user can download an application onto an e-reader device, to obtain functionality such as described herein, as well as to communicate with the network service 120. Alternatively, an application can be embedded or otherwise preinstalled with other programmatic elements for providing functionality such as described with system 300.

The service interface 340 includes application logic which enables the e-reader device 110 to use, for example, a wireless Internet connection, to connect to the network service 120 (see FIG. 1). In connecting with the service, the service interface 340 can transmit data that enables the network service 120 to identify the e-reader device 110 on which system 300 is implemented, so that the network service 120 can determine the account that is associated with the particular e-reader device. The service interface 340 can be used to retrieve e-books 325 from the network service 120. For example, in identifying the e-reader device 110 of system 300 to the network service 120, the network service may be able to procure payment information (e.g., stored credit card information) that can be used to charge the user's account when the user purchases a new e-book from the service. Each e-book can correspond to a literary work having a pagination format, such as provided by literary works (e.g., novels) and periodicals (e.g., magazines, comic books, journals, etc.). Optionally, some e-books may have chapter designations, as well as content that corresponds to graphics or images (e.g., such as in the case of magazines or comic books). Individual e-books 325 can also include metadata 327, such as imagery provided as a cover for the e-book when the e-book is marketed (e.g. similar to the manner in which a conventional hardbound book would be marketed in a retail store). In one implementation, the network service 120 can retrieve or otherwise identify the imagery and other metadata 327 of individual e-books from publisher sources.

In identifying the e-reader device of system 300, the network service 120 can identify what e-books belong to the account associated with the particular device. The e-books that are transmitted to the e-reader device of system 300 include those e-books that are purchased from the device, or those e-books that the user requested to download. In variations, e-books can be automatically downloaded to the device in response to occurrence of certain conditions. For example, the user can purchase an e-book on another device, and then subsequently connect to the network service 120 via the e-reader device 110 to automatically receive their previously purchased e-book. As another example, network service 120 can be configured to push e-books to the e-reader device 110 of system 300, based on, for example, user account settings, subscription plans and rules, and various other business logic considerations.

Additionally, the service interface 340 can include processes for automatically receiving updates from a network service 120. The update can include programmatic updates, including updates to software components on the e-reader device 110, as well as updates to lists, download of e-books that the user may have purchased on another device of the same account, recommendations from the network as to what a given user may want to purchase or view, and/or various other data that can be either generally provided to the user of the network service or specifically provided for to the particular account or user.

According to some embodiments, the local memory 330 stores each e-book as a record 326 that includes metadata 327 and content 329 (e.g., page content). The management module 320 can retrieve portions of individual e-books for purpose of rendering e-books via the user interface 310.

In an example of FIG. 3, the user interface 310 of e-book system 300 includes an e-reader component 308 and a library view component 314. Additionally, logic corresponding to a gift feature 316 can be provided with the user-interface 310. The library view 314 can display objects and metadata that represent individual e-books and content items of the user library. In one implementation, the library view 314 can display metadata content based on the metadata portion 327 of individual e-books that are in the user library. The e-books that are in the user library can correspond to e-books stored with local memory 330, as well as archived e-books there are stored remotely (e.g., provided on network service 120).

The e-reader component 308 can render page views 315 from a particular e-book, and include functionality to detect page events 313. The page views 315 can include the content portion 329 of the e-book being read (e.g., opened or rendered). For example, the e-reader component 308 can display a page view 315 from an e-book corresponding to a novel or periodical, and the page view may include text and/or image content. The page event 313 can correspond to, for example, a page turn, a chapter turn, or the user signaling to transition pages by clusters.

In one implementation, the gift feature 316 is provided as an integrated component of the e-reader component 308, so that the gift feature 316 is available when the user is reading an e-book. The gift feature 316 can be activated by user input to identify the e-book being rendered (i.e., the e-book being read), as well as other information such as an identifier of the recipient (e.g., e-mail address for the recipient).

In one implementation, gift feature 316 implements a process in which one or more interfaces are displayed to the reader in order for the reader to provide information for completing the gifting of the e-book that is rendered. The gift feature 316 can pre-populate the interface to identify the e-book being read, and further provide features for enabling the reader to determine the identifier 339 of the recipient of the gift, such as by way of email address or name. Still further, in one variation, the recipient of the e-book can be selected from a list of recipients that the user has previously identified (e.g. for receiving gifts), or whom the user has previously gifted.

In one aspect, gift feature 316 can obtain an identifier 341 for the e-book from metadata provided to or through the e-reader component 308. In one variation, the gift feature 316 can predetermine an identifier 337 of the user with regard to, for example, network service 120. Alternatively, the service interface 340 or other resource of the e-reader device 110 can obtain the user identifier 337. Still further, in one implementation, the gift feature 316 can obtain the identifier 339 of the recipient from input of the user. For example, the gift feature can trigger an interface or workflow where the user can enter an email address or other identifier of the recipient. In one aspect, the gift feature 316 generates at least a portion of the gift communication 335 which includes the user identifier 337, recipient identifier 339, and the identifier 341 of the e-book that is rendered and being viewed by the user when the gift feature 316 is triggered.

The gift communication 335 can be communicated via the service interface 340 to, for example network service 120 (or other external site where e-books can be downloaded or otherwise obtained), where the communication 335 can be acted upon. In particular, the network service 120 can identify the recipient from the recipient identifier 339, further credit the account 135 identified by the recipient identifier 339, and still further debit the account 125 of the user identified by user identifier 337.

In one implementation, the device of e-book system 300 is linked to the particular account 125 of the user, and many of the required to gift an e-book on the conventional approaches can be automated, or substantially automated. Such an approach can lessen the manual burden required from the user to gift an e-book, and further facilitates gifting actions to be acted on by the user by impulse, such as when the user completes an e-book that he or she has enjoyed. Among other benefits, the amount of user interaction required to gift a particular e-book can include the user simply activating the gift feature (e.g., selecting an icon) and further providing input to identify the recipient. In variations, the user can provide other information, such as credit card information or other account information in order to enable the gift transaction to be completed.

As described with some examples, completion of the transaction can include debiting the account 125 of the user of funds. As a variation, completion of the transaction can include debiting the account 125 of the user of the particular e-book that is being gifted. In this way, the user can gift the particular e-book as a second transaction (e.g., as a “used” e-book).

Methodology

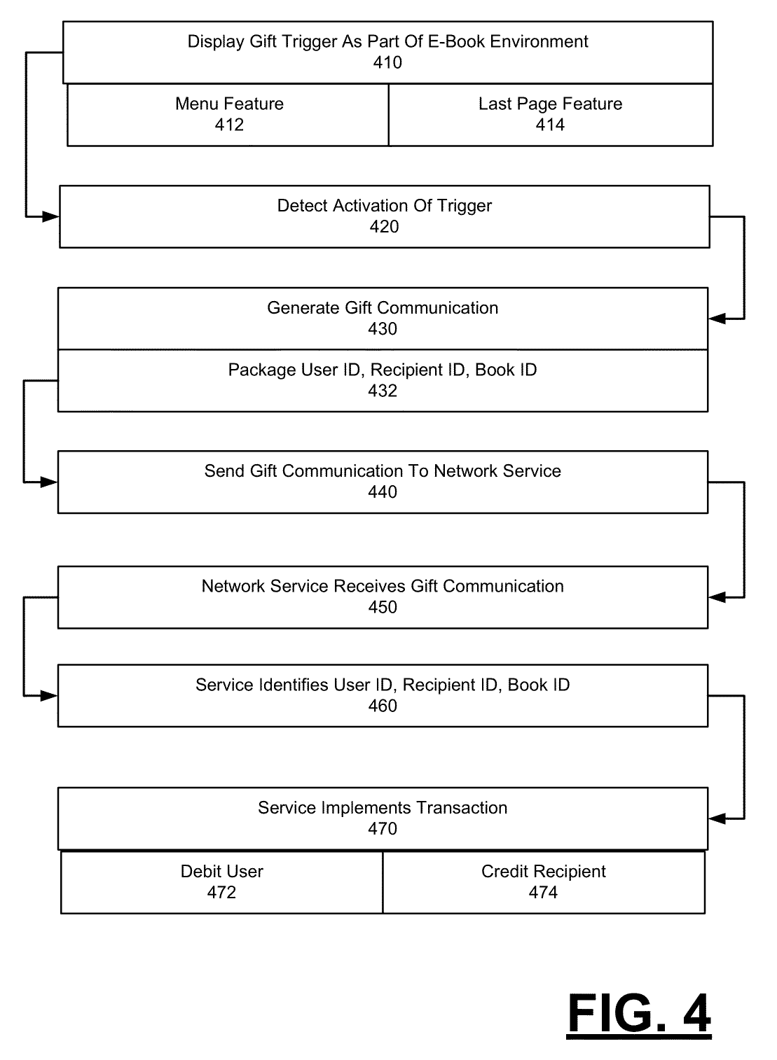

FIG. 4 illustrates an example method for enabling a user to gift an e-book, according to one or more embodiments. In describing an example of FIG. 4, reference may be made to elements described with FIG. 3 and other figures, for purpose of illustrating suitable components for performing a step or sub-step being described.

With reference to FIG. 4, gift trigger 316 can be displayed as part of the environment in which a particular e-book is being rendered (410). For example, the gift trigger 316 can be integrated with the e-book environment when an e-book is open, or alternatively provided as an overlay with, or integrated feature of a page of the e-book.

In one implementation, the gift trigger 316 can be displayed as part of the menu feature (412) for the e-book environment. For example, menu features provided with a particular e-book can include settings, where the user can for example change fonts, or display size, or look up words. Typically, the menu features provided with e-books are included in the framework of the e-book environment. In one implementation, the gift trigger 316 can be displayed as an icon or other input feature with other menu features of the e-book environment. As another example, the gift trigger 316 can be displayed as a feature or prompt that appears in response to the particular page of an e-book being viewed. For example, the gift trigger 316 can be provided as a last page feature, so as to appear when the last page is displayed. Alternatively, the gift trigger 316 can be provided with a designated page, such as the page before the epilogue of the particular e-book is being viewed. In such variations, the gift trigger 316 can be provided as an overlay feature, or alternatively in the form of a prompt that appears when the last or designated page of an e-book is viewed.

Activation of the gift trigger 316 can be detected when the e-book is displayed (420). The activation can be the form of an input from the user, such as the user contacting the screen at a location coinciding with a display of the gift trigger 316. In variations, a microphone, button, keyboard entry or other input mechanism may be used to activate the gift trigger 316.

In response to the activation of the gift trigger 316, a gift communication can be generated (430). The gift communication includes identifiers and other data necessary for network service 120 (or alternatively, a third-party service) to transact the e-book being read to a particular recipient of the user selection. In particular, the effect of the transaction can be to convey to the recipient a right to possess the e-book, either permanently or temporarily (e.g., on a loan basis). In one implementation, the gift communication packages the user identifier, the recipient identifier, and the e-book identifier (432). The e-book identifier can be determined automatically from the e-book that the user is reading, such as indicated by the e-book that is opened on the e-reader device, or by the e-book from which a last page view was rendered.

The e-reader device 110 can send the gift communication to the network service 120 (440). As mentioned, alternative network services can be selected or used, based on considerations such as the preference of the user.

In one implementation, the network service receives the gift communication from the e-reader device (450). The network service can process the gift communication in order to determine the user identifier, the recipient identifier, and the e-book identifier (460).

The service can then implement the transaction (470). In particular, the transaction can be implemented by debiting the account 125 of the user (472), and further by crediting the account 135 of the recipient identified by the gift communication (474). The transaction logic 132 can, for example, credit of the account 135 of the recipient by associating the gifted e-book to that particular recipient account. Depending on implementation, the transaction logic 132 can credit the account of the user either permanently or temporarily, depending on the type of transaction (e.g., complete ownership versus loan). The transaction logic 132 can debit the account 125 of the user by withdrawing funds from the account 125 of the user, or alternatively by disassociating the gifted e-book for the particular account 125.

### EXAMPLES

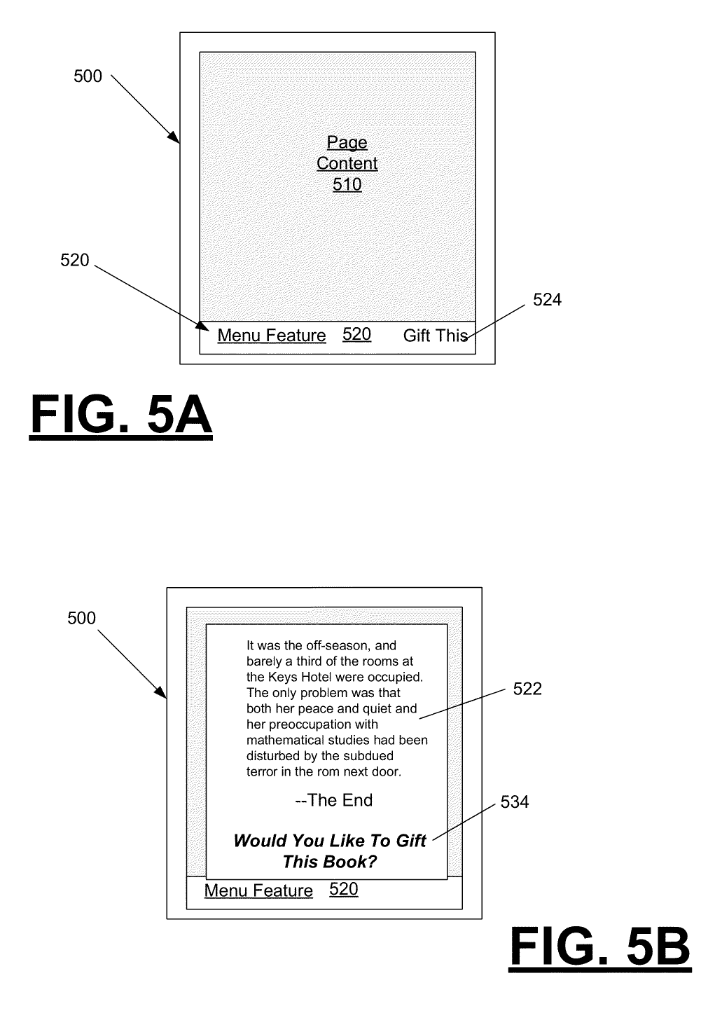

FIG. 5A through FIG. 5C illustrate variations of examples for providing and in e-book gift feature, according to one or more embodiments. In an example of FIG.5A, an e-reader device 500 displays page content 510 from a particular e-book. The e-reader device 500 can provide menu features 520 in a framework that defines the e-reading environment in which the page content 510 is provided. In an example of FIG. 5A, feature 524 corresponding to a gift trigger that is provided as part of the menu feature 520. In one implementation, feature 524 can be persistently present and/or available (e.g., with each page view) while the user reads the particular e-book. At any point while the user is reading the e-book, the user can select to activate the gift feature 524 in order to initiate a process in which the recipient of the gift is identified. Once the gift feature 524 is activated, a gift communication is generated that can be communicated to the network service 120 (or alternatively, to another network service). The gift communication can be used to implement the gift exchange.

FIG. 5B illustrates in example in which a gift feature is displayed with a particular section or page of an e-book. For example, the e-reader device 500 can render an end portion 522 of an e-book. Upon displaying the end portion 522, a gift feature 534 can be displayed as a prompt that the user can act upon. For example, the user can select the prompt, or perform some other input action to initiate a process in which the particular e-book that was just completed can be gifted to a designated recipient. Accordingly, in an example of FIG. 5B, the gift feature 534 is provided in response to an event, such as detection of a designated portion (e.g., a last passage) of the e-book being read or completed.

In an example of FIG. 5C, the gift feature can be provided as an invisible (e.g., touch-only) input feature that is separate from the menu feature 520. For example, a designated portion 544 of the display screen for the e-reader device 500 can be responsive to input that is indicative of the user wishing to gift the particular e-book that is opened to a recipient. The user can tap the region 544 of the display screen in order to initiate a process in which the recipient is identified for the gift transaction.

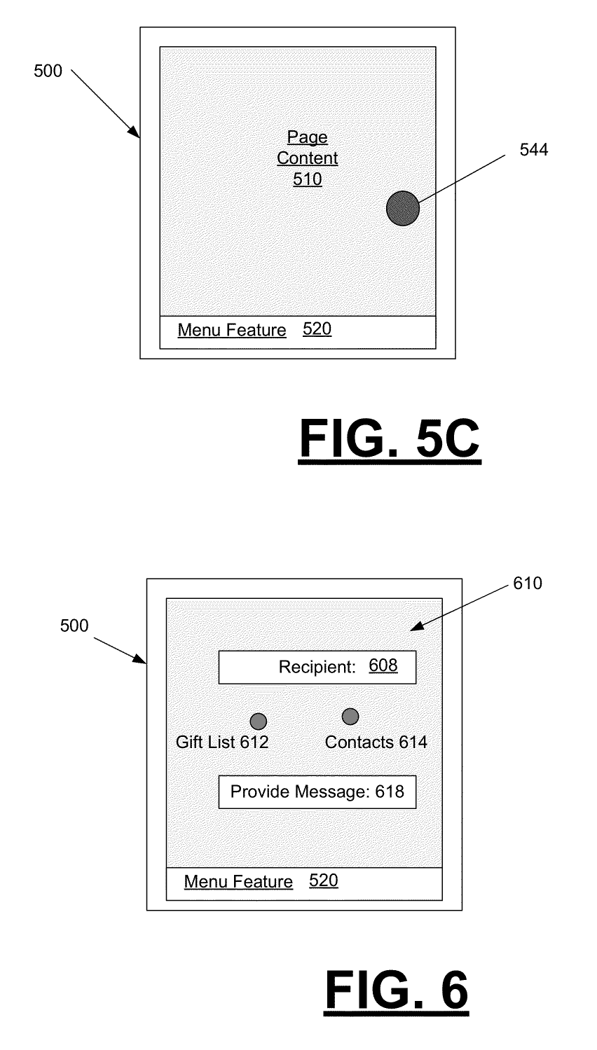

FIG. 6 illustrates an example interface that can be displayed when a gift trigger feature is activated. In an example of FIG. 6, an interface 610 is displayed on the display screen of the e-reader device 500. The interface 610 can include one or more programmatic mechanisms for enabling the user to identify the recipient. By way of example, the interface 610 can include a field 608 to enable the recipient can be identified by email address, first and last name, or account identifier. The interface 610 can also provide a contact feature 614 to enable user can also identify the recipient from a contact record stored on the e-reader device 500. Still further, the interface 610 can provide a feature 612 to enable the user to identify the recipient from a list, such as from a list of individuals whom the user has preselected as being potential gift recipients, or those users whom the user as previously gifted e-books to. As an addition or alternative, the interface 610 can also include a feature 618 to enable the user to provide a message for the recipient.

Information provided by the user through interface 610 can be used to generate, for example, a portion of the gift communication 335 (see FIG. 3). Other aspects of the gift communication 335 can be generated from the device identifier, as well as from the e-book identifier, as determined from the e-book being read by the user.

In one aspect, the interface 610 is displayed as an overlay or integrated aspect to the page view of an e-book. In this way, the user is not navigated away from the reading environment when performing the gifting action.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A computing device comprising:
a memory resource that stores an e-book and a set of instructions;
one or more processors that access instructions stored in the memory resource in order to:
display a user activatable trigger with a content portion of the e-book when the e-book is rendered for reading;
detect activation of the trigger by user input;
generate a communication for a network service where the e-book is available for download, the communication including an identifier for each of the e-book, the user, and a recipient;
send the communication to the network service.

2. The computing device of claim 1, wherein the one or more processors automatically generate the communication in response to detecting activation of the trigger.

3. The computing device of claim 1, wherein the one or more processors automatically send the communication to the network service in response to detecting activation of the trigger.

4. The computing device of claim 1, wherein the one or more processors display the user activatable trigger within a boundary of an application framework in which the content portion of the e-book is displayed.

5. The computing device of claim 4, wherein the one or more processors display the user activatable trigger as an icon that appears on a rendered page of the e-book.

6. The computing device of claim 4, wherein the one or more processors display the user activatable trigger as an icon that appears in a feature bar provided as part of the framework.

7. The computing device of claim 1, wherein the one or more processors access instructions in the memory resource to detect when the user completes the e-book, then displays the user activatable trigger in response to detecting the user completing the e-book.

8. The computing device of claim 1, wherein the one or more processors detect activation of the trigger by user input corresponding to the user contacting a display screen.

9. The computing device of claim 1, wherein the e-book corresponds to a periodical, and wherein the identifier for the e-book provide with the communication identifies a title and an issue of the periodical.

10. A method for gifting an e-book, the method comprising:
on a computing device:
displaying a user activatable trigger with a content portion of the e-book when the e-book is rendered for reading;
detecting activation of the trigger by user input;
generating a communication for a network service where the e-book is available for download, the communication identifying the e-book;
sending the communication to the network service; on one or more servers of the network service:
receiving the communication from the computing device;
identifying, from the communication, the e-book, an account of the user and an account of a recipient;
crediting the e-book for the recipient; and
debiting the account of the user for the e-book.

11. The method of claim 10, wherein crediting the e-book for the account of the recipient includes making the e-book available for download by the recipient.

12. The method of claim 10, further comprising sending a notification to the recipient in response to receiving the communication from the computing device.

13. The method of claim 10, further comprising automatically downloading the e-book onto a computing device of the recipient in response to receiving the communication from the computing device.

14. The method of claim 10, further comprising determining that the recipient does not have an account with the network service, then sending the recipient a notification to download the e-book.

15. The method of claim 10, wherein the e-book corresponds to a periodical, and wherein the identifier for the e-book provide with the communication identifies a title and an issue of the periodical.

16. The method of claim 10, wherein generating the communication is performed automatically in response to detecting activation of the trigger.

17. The method of claim 10, wherein sending the communication is performed automatically in response to detecting activation of the trigger.

18. The method of claim 10, wherein displaying the user activatable trigger includes displaying the user activatable trigger within an application framework in which the content portion of the e-book is displayed.

19. The method of claim 10, further comprising:
detecting when the user completes the e-book; and
displaying the user activatable trigger in response to detecting the user completing the e-book.

20. A non-transitory computer-readable medium that stores instructions, that when executed by one or more processors of a computing device, cause the computing device to perform operations that include:
displaying a user activatable trigger with a content portion of an e-book when the e-book is rendered for reading;
detecting activation of the trigger by user input;
generating a communication for a network service where the e-book is available for download, the communication including an identifier for each of the e-book, the user, and a recipient;
sending the communication to the network service.
